(19) United States
(12) Patent Application Publication
(10) Pub. No.: US 2025/0358913 A1
(43) Pub. Date: Nov. 20, 2025

(54) Load Control Device for a Light-Emitting Diode Light Source

(71) Applicant: Lutron Technology Company LLC, Coopersburg, PA (US)

(72) Inventors: Timothy P. Gredler, Center Valley, PA (US); Matthew R. Zartman, Bethlehem, PA (US)

(73) Assignee: Lutron Technology Company LLC, Coopersburg, PA (US)

(21) Appl. No.: 19/284,975

(22) Filed: Jul. 30, 2025

Related U.S. Application Data
(63) Continuation of application No. 18/602,360, filed on Mar. 12, 2024, now Pat. No. 12,382,559.
Application No. 18/602,360 is a continuation of application No. 18/297,697, filed on Apr. 10, 2023, now Pat. No. 11,979,955.
Application No. 18/297,697 is a continuation of application No. 17/881,774, filed on Aug. 5, 2022, now Pat. No. 11,653,431.
Application No. 17/881,774 is a continuation of application No. 17/001,050, filed on Aug. 24, 2020, now Pat. No. 11,412,593.
Application No. 17/001,050 is a continuation of application No. 16/601,845, filed on Oct. 15, 2019, now Pat. No. 10,757,773.
Application No. 16/601,845 is a continuation of application No. 16/378,134, filed on Apr. 8, 2019, now Pat. No. 10,448,473.
Application No. 16/378,134 is a continuation of application No. 15/953,812, filed on Apr. 16, 2018, now Pat. No. 10,257,897.
Application No. 15/953,812 is a continuation of application No. 15/717,123, filed on Sep. 27, 2017, now Pat. No. 9,949,330.
Application No. 15/717,123 is a continuation of application No. 15/460,973, filed on Mar. 16, 2017, now Pat. No. 9,814,112.
Application No. 15/460,973 is a continuation of application No. 15/291,308, filed on Oct. 12, 2016, now Pat. No. 9,635,726.
Application No. 15/291,308 is a continuation of application No. 14/796,278, filed on Jul. 10, 2015, now Pat. No. 9,497,817.
Application No. 14/796,278 is a continuation of application No. 14/290,584, filed on May 29, 2014, now Pat. No. 9,113,521.
(60) Provisional application No. 61/828,337, filed on May 29, 2013.

(51) Int. Cl. H05B 45/3725; H05B 45/10; H05B 45/335; H05B 45/375; H05B 45/385; H05B 45/395

(52) U.S. Cl. CPC H05B 45/3725; H05B 45/10; H05B 45/335; H05B 45/375; H05B 45/385; H05B 45/395

(57) ABSTRACT

A load control device for controlling the intensity of a lighting load, such as a light-emitting diode (LED) light source, may include a power converter circuit operable to receive a rectified AC voltage and to generate a DC bus voltage, a load regulation circuit operable to receive the bus voltage and to control the magnitude of a load current conducted through the lighting load, and a control circuit operatively coupled to the load regulation circuit for pulse width modulating or pulse frequency modulating the load current to control the intensity of the lighting load to a target intensity. The control circuit may control the intensity of the lighting load by pulse width modulating the load current when the target intensity is above a predetermined threshold and control the intensity of the lighting load by pulse frequency modulating the load current when the target intensity is below the predetermined threshold.

### CROSS REFERENCE TO RELATED APPLICATIONS

This application is a continuation of U.S. patent application Ser. No. 18/602,360, filed Mar. 12, 2024; which is a continuation of U.S. patent application Ser. No. 18/297,697, filed Apr. 10, 2023, now U.S. Pat. No. 11,979,955 issued May 7, 2024; which is a continuation of U.S. patent application Ser. No. 17/881,774, filed on Aug. 5, 2022, now U.S. Pat. No. 11,653,431, issued May 16, 2023; which is a continuation of U.S. patent application Ser. No. 17/001,050, filed on Aug. 24, 2020, now U.S. Pat. No. 11,412,593, issued Aug. 9, 2022; which is a continuation of U.S. patent application Ser. No. 16/601,845, filed on Oct. 15, 2019, now U.S. Pat. No. 10,757,773 issued Aug. 25, 2020; which is a continuation of U.S. patent application Ser. No. 16/378,134, filed on Apr. 8, 2019 now U.S. Pat. No. 10,448,473 issued Oct. 15, 2019; which is a continuation of U.S. patent application Ser. No. 15/953,812, filed on Apr. 16, 2018 now U.S. Pat. No. 10,257,897 issued Apr. 9, 2019; which is a continuation of U.S. patent application Ser. No. 15/717,123, filed on Sep. 27, 2017, now U.S. Pat. No. 9,949,330 issued Apr. 17, 2018; which is a continuation of U.S. patent application Ser. No. 15/460,973, filed Mar. 16, 2017, now U.S. Pat. No. 9,814,112 issued Nov. 7, 2017; which is a continuation of U.S. patent application Ser. No. 15/291,308, filed Oct. 12, 2016, now U.S. Pat. No. 9,635,726 issued Apr. 25, 2017; which is a continuation of U.S. patent application Ser. No. 14/796,278, filed Jul. 10, 2015, now U.S. Pat. No. 9,497,817 issued Nov. 15, 2016; which is a continuation of U.S. patent application Ser. No. 14/290,584, filed May 29, 2014, now U.S. Pat. No. 9,113,521 issued Aug. 18, 2015; which claims the benefit of U.S. Provisional Patent Application No. 61/828,337, filed May 29, 2013, the contents of which are hereby incorporated by reference in their entirety.

### BACKGROUND

Light-emitting diode (LED) light sources are often used in place of or as replacements for conventional incandescent, fluorescent, or halogen lamps, and the like. LED light sources may comprise a plurality of light-emitting diodes mounted on a single structure and provided in a suitable housing. LED light sources are typically more efficient and provide longer operational lives as compared to incandescent, fluorescent, and halogen lamps. In order to illuminate properly, an LED driver control device (i.e., an LED driver) may be coupled between a power source (e.g., an alternating-current (AC) source) and the LED light source for regulating the power supplied to the LED light source. The LED driver may regulate either the voltage provided to the LED light source to a particular value, the current supplied to the LED light source to a specific peak current value, or may regulate both the current and voltage.

LED light sources may comprise a plurality of individual LEDs that may be arranged in a series and parallel relationship. In other words, a plurality of LEDs may be arranged in a series string and a number of series strings may be arranged in parallel to achieve the desired light output. For example, five LEDs in a first series string each with a forward bias of approximately three volts (V) and each consuming approximately one watt of power (at 350 mA through the string) consume about 5 W. A second string of a series of five LEDs connected in parallel across the first string will result in a power consumption of 10 W with each string drawing 350 mA. Thus, an LED driver would supply 700 mA to the two strings of LEDs, and since each string has five LEDs, the output voltage provided by the LED driver would be about 15 volts. Additional strings of LEDs can be placed in parallel for additional light output, however, the LED driver should be operable to provide the necessary current. Alternatively, more LEDs can be placed in series on each string, and as a result, the LED driver should also be operable to provide the necessary voltage (e.g., 18 volts for a series of six LEDs).

LED light sources are typically rated to be driven via one of two different control techniques: a current load control technique or a voltage load control technique. An LED light source that is rated for the current load control technique is also characterized by a rated current (e.g., 350 milliamps) to which the peak magnitude of the current through the LED light source should be regulated to ensure that the LED light source is illuminated to the appropriate intensity and color. In contrast, an LED light source that is rated for the voltage load control technique is characterized by a rated voltage (e.g., 15 volts) to which the voltage across the LED light source should be regulated to ensure proper operation of the LED light source. Typically, each string of LEDs in an LED light source rated for the voltage load control technique includes a current balance regulation element to ensure that each of the parallel legs has the same impedance so that the same current is drawn in each parallel string.

In addition, it is known that the light output of an LED light source can be dimmed. Different methods of dimming LEDs include a pulse-width modulation (PWM) technique and a constant current reduction (CCR) technique. Pulse-width modulation dimming can be used for LED light sources that are controlled in either a current or voltage load control mode. In pulse-width modulation dimming, a pulsed signal with a varying duty cycle is supplied to the LED light source. If an LED light source is being controlled using the current load control technique, the peak current supplied to the LED light source is kept constant during an on time of the duty cycle of the pulsed signal. However, as the duty cycle of the pulsed signal varies, the average current supplied to the LED light source also varies, thereby varying the intensity of the light output of the LED light source. If the LED light source is being controlled using the voltage load control technique, the voltage supplied to the LED light source is kept constant during the on time of the duty cycle of the pulsed signal in order to achieve the desired target voltage level, and the duty cycle of the load voltage is varied in order to adjust the intensity of the light output. Constant current reduction dimming is typically only used when an LED light source is being controlled using the current load control technique. In constant current reduction dimming, current is continuously provided to the LED light source, however, the DC magnitude of the current provided to the LED light source is varied to thus adjust the intensity of the light output.

However, an LED light source may become instable or exhibit undesirable characteristics when dimmed to a low intensity level or when dimmed to off (i.e., 0% intensity). For example, when dimmed to a low intensity level or off, an LED light source may flicker, may exhibit inconsistent brightness or color across the individual LEDs of the LED light source, and/or may suddenly drop in intensity during the dimming procedure (e.g., from approximately 1% to off). For instance, when dimming an LED light source using the PWM technique, the on time of the duty cycle of the pulsed signal may reach a threshold where, if reduced any further, causes the LED light source to become instable or exhibit undesirable characteristics. Similarly, when dimming an LED light source using the CCR technique, the DC magnitude of the current provided to the LED light source may reach a threshold where, if reduced any further, causes the LED light source to become instable or exhibit undesirable characteristics.

### SUMMARY

As described herein, a load control device for controlling (e.g., dimming) an intensity of a lighting load to a low intensity level and/or off is provided. The load control device may comprise a power converter circuit, a load regulation circuit, and/or a control circuit. The power converter circuit may be operable to receive a rectified AC voltage and to generate a DC bus voltage. The load regulation circuit may be operable to receive the DC bus voltage and to control a magnitude of a load current conducted through the lighting load, for example, using the DC bus voltage. The control circuit may be operatively coupled to the load regulation circuit for pulse width modulating and/or pulse frequency modulating the load current to control the intensity of the lighting load to a target intensity. The lighting load may comprise an LED light source. The load regulation circuit may comprise an LED drive circuit.

The control circuit may be configured to control the intensity of the lighting load by pulse width modulating the load current when the target intensity is above a predetermined threshold and control the intensity of the lighting load by pulse frequency modulating the load current when the target intensity is below the predetermined threshold. The predetermined threshold may be, for example, a low-end intensity (e.g., 1%). Pulse width modulating the load current may comprise maintaining a frequency of the load current constant and adjusting an on time of the load current. Pulse frequency modulating the load current may comprise maintaining the on time of the load current constant and adjusting the frequency of the load current.

For example, the control circuit may be configured to maintain the frequency of the load current at a normal pulse width modulation (PWM) frequency and adjust the on time of the load current between a maximum on time and a minimum on time when the target intensity is above the predetermined threshold, for example, when the target intensity is between a high-end intensity and the low-end intensity. The control circuit may be configured to maintain the on time of the load current at the minimum on time and adjust the frequency of the load current between the normal PWM frequency and a minimum PWM frequency when the target intensity is below the predetermined threshold, for example, when the target intensity is between the low-end intensity and a minimum intensity. The minimum intensity may be below (i.e., less than) the low-end intensity. The control circuit may be configured to maintain the frequency of the load current at the minimum PWM frequency and adjust the on time of the load current between the minimum on time and an ultra-low minimum on time when the target intensity is below the minimum intensity, for example, when the target intensity is between the minimum intensity and an ultra-low minimum intensity. For instance, the control circuit may dim the LED light source to off (i.e., the ultra-low minimum intensity may be 0% intensity).

The control circuit may be configured to dim the LED light source to off. For example, the control circuit may be configured to pulse width modulate the load current when the target intensity is below the minimum intensity, which is below the predetermined threshold (e.g., a low-end intensity). As such, the control circuit may be configured to control the intensity of the lighting load from the minimum intensity to off by pulse width modulating the load current. The control circuit may be configured to control the intensity of the lighting load from the predetermined threshold to off by pulse frequency modulating the load current. The control circuit may be configured to maintain a frequency of the load current constant, maintain an on time of the load current constant, and decrease a magnitude of the DC bus voltage when the target intensity is below the minimum intensity. For example, control circuit may control the intensity of the lighting load to off by decreasing the magnitude of the DC bus voltage.

The control circuit may be configured to control the intensity of the lighting load by pulse width modulating the load current when the target intensity is within a first intensity range and control the intensity of the lighting load by pulse frequency modulating the load current when the target intensity is within a second intensity range. The first intensity range may be greater than or less than the second intensity range. The control circuit may be configured to receive a command and control (e.g., dim) the intensity of the lighting load below the first intensity range and below the second intensity range to off. For example, the load control circuit may be configured to control the intensity of the lighting load below the second intensity range to off by pulse width modulating and/or pulse frequency modulating the load current. The load control circuit may be configured to control the intensity of the lighting load below the first intensity range and below the second intensity range to off by maintaining the frequency of the load current constant, maintaining the on time of the load current constant, and decreasing the magnitude of the DC bus voltage.

### BRIEF DESCRIPTION OF THE DRAWINGS

FIG. 1 is a block diagram of an example system that comprises a light-emitting diode (LED) driver for controlling the intensity of an LED light source.

FIG. 2 is a block diagram of an example of an LED driver for controlling the intensity of an LED light source.

FIG. 3A is a schematic diagram of an example of a flyback converter and an LED drive circuit.

FIG. 3B is a schematic diagram showing an example the LED drive circuit of FIG. 3A.

FIG. 4A is a graph that illustrates an example of the relationship between an on-time T_{ON} of a load current of an LED driver and a target lighting intensity L_{TRGT} of an LED light source.

FIG. 4B is a graph that illustrates an example of the relationship between a frequency f_{LOAD} of a load current of an LED driver and a target lighting intensity L_{TRGT} of an LED light source.

FIG. 5A is a graph that illustrates an example of the relationship between an on-time T_{ON} of a load current of an LED driver and a target lighting intensity L_{TRGT} of an LED light source.

FIG. 5B is a graph that illustrates an example of the relationship between a frequency f_{LOAD} of a load current of an LED driver and a target lighting intensity L_{TRGT} of an LED light source.

### DETAILED DESCRIPTION

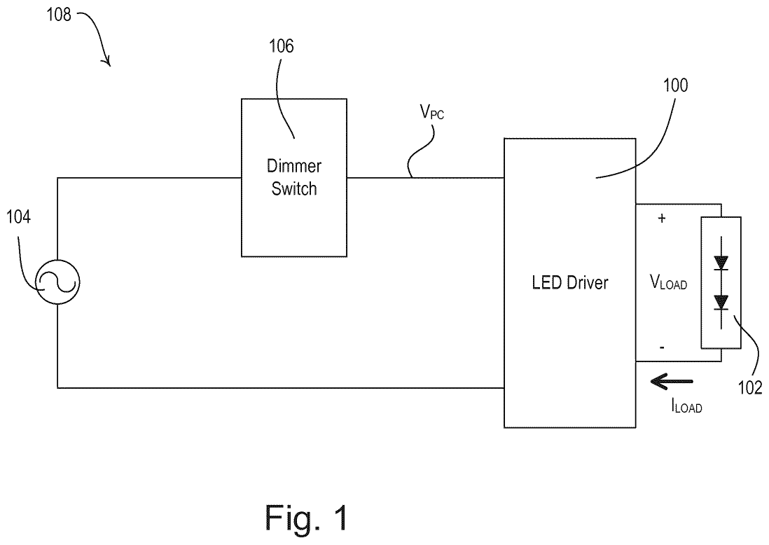

FIG. 1 is a block diagram of an example system that comprises a light-emitting diode (LED) driver for controlling the intensity of an LED light source. A system 108 may comprise an alternating-current (AC) power source 104, a dimmer switch 106, an LED driver 100, and/or an LED light source 102. The LED driver 100 may control an intensity of the LED light source 102. An example of the LED light source 102 may be an LED light engine. The LED light source 102 is shown as a plurality of LEDs connected in series but may comprise a single LED or a plurality of LEDs connected in series, parallel, or a suitable combination thereof, for example, depending on the particular lighting system. The LED light source 102 may comprise one or more organic light-emitting diodes (OLEDs).

The LED driver 100 may be coupled to the AC power source 104 via the dimmer switch 106. The dimmer switch 106 may generate a phase-control signal V_{PC} (e.g., a dimmed-hot voltage). The dimmer switch 106 may provide the phase-control signal V_{PC} to the LED driver 100. The dimmer switch 106 may comprise a bidirectional semiconductor switch (not shown), such as, for example, a triac or two anti-series-connected field-effect transistors (FETs), which may be coupled in series between the AC power source 104 and the LED driver 100. The dimmer switch 106 may control the bidirectional semiconductor switch to be conductive for a conduction period T_{CON} each half-cycle of the AC power source 104 to generate the phase-control signal V_{PC}.

The LED driver 100 may turn the LED light source 102 on and off in response to the conduction period T_{CON} of the phase-control signal V_{PC} received from the dimmer switch 106. The LED driver 100 may adjust (i.e., dim) a present intensity L_{PRES} of the LED light source 102 to a target intensity L_{TRGT} in response to the phase-control signal V_{PC}. The target intensity L_{TRGT} may range across a dimming range of the LED light source 102. For example, the dimming range of the LED light source 102 may be between a low-end intensity L_{LE} (e.g., approximately 1%) and a high-end intensity L_{HE} (e.g., approximately 100%). The LED driver 100 may control the magnitude of a load current I_{LOAD} through the LED light source 102 and/or the magnitude of a load voltage V_{LOAD} across the LED light source. Accordingly, the LED driver 100 may control at least one of the load voltage V_{LOAD} across the LED light source 102 and the load current I_{LOAD} through the LED light source to control the amount of power delivered to the LED light source, for example, depending upon a mode of operation of the LED driver (e.g., as described herein).

The LED driver 100 may work with (i.e., control) a plurality of different LED light sources. For example, the LED driver 100 may work with LED lights sources that are rated to operate using different load control techniques, different dimming techniques, and/or different magnitudes of load current and/or voltage. The LED driver 100 may control the magnitude of the load current I_{LOAD} through the LED light source 102 and/or the load voltage V_{LOAD} across the LED light source using different modes of operation. For example, the LED driver 100 may use a current load control mode (i.e., for using the current load control technique) and/or a voltage load control mode (i.e., for using the voltage load control technique). The LED driver 100 may adjust the magnitude to which the LED driver 100 controls the load current I_{LOAD} through the LED light source 102 in the current load control mode. The LED driver 100 may adjust the magnitude to which the LED driver 100 controls the load voltage V_{LOAD} across the LED light source in the voltage load control mode.

When operating in the current load control mode, the LED driver 100 may control the intensity of the LED light source 102 using a PWM dimming mode (i.e., for using the PWM dimming technique), a CCR dimming mode (i.e., for using the CCR dimming technique), and/or a pulse frequency modulation (PFM) dimming mode (i.e., for using the PFM dimming technique). In the PWM dimming mode, the LED driver 100 may control the load current I_{LOAD} by altering the pulse duration of the load current I_{LOAD} and maintaining the frequency of the load current I_{LOAD} constant. In the PFM dimming mode, the LED driver 100 may control the load current I_{LOAD} by maintaining the pulse duration of the load current I_{LOAD} constant and altering the frequency of the load current I_{LOAD}. In the CCR dimming mode, the LED driver 100 may control the load current I_{LOAD} by altering the DC magnitude of the current load current I_{LOAD}. When operating in the voltage load control mode, the LED driver 100 may control the amount of power delivered to the LED light source 102 using the PWM dimming mode and/or the PFM dimming mode. The LED driver 100 may control the amount of power delivered to the LED light source 102 in response to a digital message, which may be received from a communication circuit, for example as described herein.

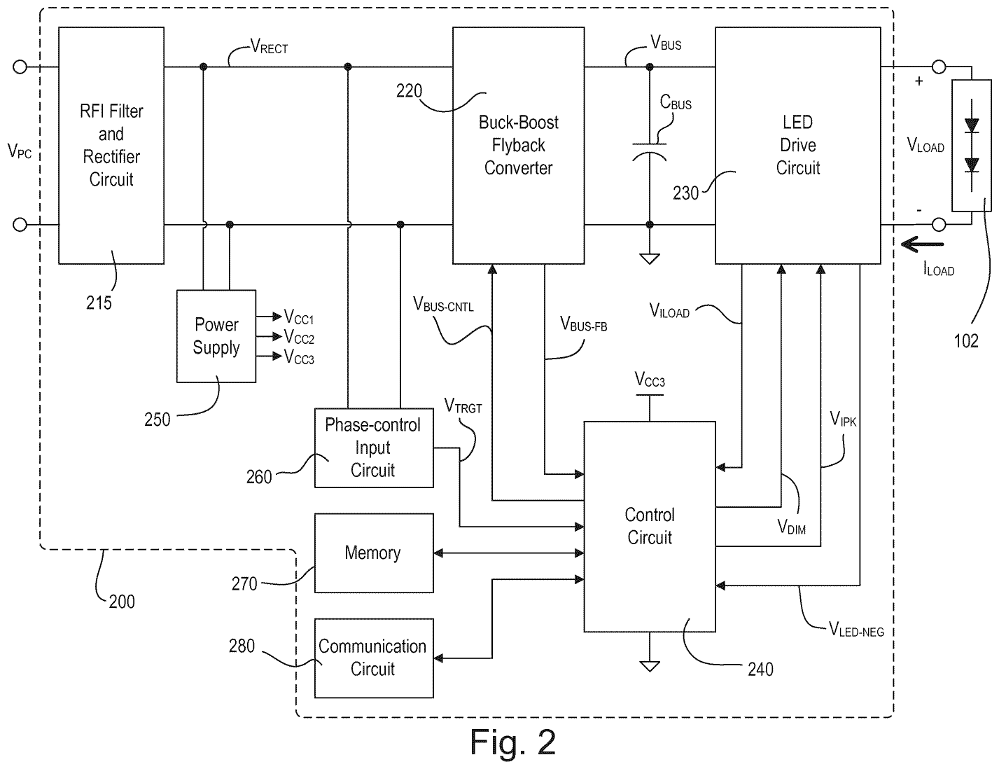

FIG. 2 is a block diagram of an example of an LED driver for controlling an LED light source. An LED driver 200 may comprise a radio-frequency (RFI) filter and rectifier circuit 215, a buck-boost flyback converter 220, a bus capacitor CBUS, an LED drive circuit 230, a control circuit 240, a power supply 250, a phase-control input circuit 260, memory 270, and/or a communication circuit 280. The LED driver 200 may be an example of the LED driver 100 of FIG. 1. As such, the LED driver 200 may be used within the system 108 of FIG. 1. The LED driver 200 may control an LED light source, such as the LED light source 102.

The RFI filter and rectifier circuit 215 may receive the phase-control signal V_{PC} from a dimmer switch (e.g., the dimmer switch 106 of FIG. 1). The RFI filter and rectifier circuit 215 may minimize the noise provided on an AC power source (e.g., the AC power source 104 of FIG. 1). The RFI filter and rectifier circuit 215 may generate a rectified voltage V_{RECT}. The buck-boost flyback converter 220 may receive the rectified voltage V_{RECT}. The buck-boost flyback converter 220 may generate a variable direct-current (DC) bus voltage V_{BUS} across the bus capacitor C_{BUS}. The buck-boost flyback converter 220 may provide electrical isolation between the AC power source and the LED light source 102. The buck-boost flyback converter 220 may operate as a power factor correction (PFC) circuit to adjust the power factor of the LED driver 200 towards a power factor of one. The buck-boost flyback converter 220 may be a power converter circuit. Although illustrated as the buck-boost flyback converter 220, the LED driver 200 may comprise any suitable power converter circuit for generating an appropriate bus voltage V_{BUS}, such as, for example, a boost converter, a buck converter, a single-ended primary-inductor converter (SEPIC), a Ćuk converter, or other suitable power converter circuit. The bus voltage V_{BUS} may be characterized by some voltage ripple as the bus capacitor C_{BUS} periodically charges and discharges.

The LED drive circuit 230 may be a load regulation circuit. The LED drive circuit 230 may receive the bus voltage V_{BUS}. The LED drive circuit 230 may control the amount of power delivered to the LED light source 102 so as to control the intensity of the LED light source 102. The LED drive circuit 230 may comprise a controllable-impedance circuit, such as a linear regulator, for example, as described herein. The LED drive circuit 230 may comprise a switching regulator, such as a buck converter for example. Examples of various embodiments of LED drive circuits 230 are described in U.S. patent application Ser. No. 12/813,908, filed Jun. 11, 2010, entitled LOAD CONTROL DEVICE FOR A LIGHT-EMITTING DIODE LIGHT SOURCE, the entire disclosure of which is hereby incorporated by reference.

The control circuit 240 may control the operation of the buck-boost flyback converter 220 and/or the LED drive circuit 230. The control circuit 240 may comprise, for example, a controller or any other suitable processing device, such as, for example, a microcontroller, a programmable logic device (PLD), a microprocessor, an application specific integrated circuit (ASIC), or a field-programmable gate array (FPGA). The power supply 250 may receive the rectified voltage V_{RECT}. The power supply 250 may generate a plurality of direct-current (DC) supply voltages for powering the circuitry of the LED driver 200, for example, using the rectified voltage V_{RECT}. For example, the power supply 250 may generate a first non-isolated supply voltage V_{CC1} (e.g., approximately 14 volts) for powering the control circuitry of the buck-boost flyback converter 220, a second isolated supply voltage V_{CC2} (e.g., approximately 9 volts) for powering the control circuitry of the LED drive circuit 230, and/or a third non-isolated supply voltage V_{CC3} (e.g., approximately 5 volts) for powering the control circuit 240.

The control circuit 240 may be coupled to the phase-control input circuit 260. The phase-control input circuit 260 may generate a target intensity control signal V_{TRGT}. The target intensity control signal V_{TRGT} may comprise, for example, a square-wave signal having a duty cycle DC_{TRGT}, which may be dependent upon the conduction period T_{CON} of the phase-control signal V_{PC} received from a dimmer switch (e.g., the dimmer switch 106 of FIG. 1). The duty cycle DC_{TRGT} may be representative of the target intensity L_{TRGT} of the LED light source 102. The target intensity control signal V_{TRGT} may comprise a DC voltage having a magnitude dependent upon the conduction period T_{CON} of the phase-control signal V_{PC}, and thus representative of the target intensity L_{TRGT} of the LED light source 102.

The control circuit 240 may be coupled to the memory 270. The memory 270 may store the operational characteristics of the LED driver 200 (e.g., the load control mode, the dimming mode, the magnitude of the rated load voltage or current, and/or the like). The communication circuit 280 may be coupled to, for example, a wired communication link or a wireless communication link, such as a radio-frequency (RF) communication link or an infrared (IR) communication link. The control circuit 240 may update the target intensity L_{TRGT} of the LED light source 102 and/or the operational characteristics stored in the memory 270 in response to digital messages received via the communication circuit 280. For example, the LED driver 200 may receive a full conduction AC waveform from the AC power source (i.e., not the phase-control signal V_{PC} from the dimmer switch) and may determine the target intensity L_{TRGT} for the LED light source 102 from the digital messages received via the communication circuit 280.

The control circuit 240 may manage the operation of the buck-boost flyback converter 220 and/or the LED drive circuit 230 to control the intensity of the LED light source 102. The control circuit 240 may receive a bus voltage feedback signal V_{BUS-FB}, which may be representative of the magnitude of the bus voltage V_{BUS}, from the buck-boost flyback converter 220. The control circuit 240 may provide a bus voltage control signal V_{BUS-CNTL} to the buck-boost flyback converter 220 for controlling the magnitude of the bus voltage V_{BUS} to a target bus voltage V_{BUS-TRGT} (e.g., from approximately 8 volts to 60 volts). The LED drive circuit 230 may control a peak magnitude I_{PK} of the load current I_{LOAD} conducted through the LED light source 102 between a minimum load current I_{LOAD-MIN} and a maximum load current I_{LOAD-MAX} (e.g., when operating in the current load control mode), for example, in response to a peak current control signal V_{IPK} provided by the control circuit 240. The control circuit 240 may receive a load current feedback signal V_{ILOAD}, which is representative of an average magnitude I_{AVE} of the load current I_{LOAD} flowing through the LED light source 102. The control circuit 240 may receive a regulator voltage feedback signal V_{REG-FB}, which is representative of the magnitude of a regulator voltage V_{REG} (i.e., a controllable-impedance voltage) across the linear regulator of the LED drive circuit 230, for example, as described herein.

The control circuit 240 may control the LED drive circuit 230 to control the amount of power delivered to the LED light source 102 using the current load control mode of operation and/or the voltage load control mode of operation. During the current load control mode, the LED drive circuit 230 may regulate the peak magnitude I_{PK} of the load current I_{LOAD} through the LED light source 102 to control the average magnitude I_{AVE} to a target load current I_{TRGT} in response to the load current feedback signal V_{ILOAD} (i.e., using closed loop control). The target load current I_{TRGT} may be stored in the memory 270. The target load current I_{TRGT} may be programmed to be any specific magnitude depending upon the LED light source 102.

To control the intensity of the LED light source 102 during the current load control mode, the control circuit 240 may control the LED drive circuit 230 to adjust the amount of power delivered to the LED light source 102 using the PWM dimming technique, the PFM dimming technique, and/or the CCR dimming technique. Using the PWM dimming technique, the control circuit 240 may control the peak magnitude I_{PK} of the load current I_{LOAD} through the LED light source 102 to the target load current I_{TRGT}. Using the PWM dimming technique, the control circuit 240 may pulse-width modulate the load current I_{LOAD} to dim the LED light source 102 and achieve the target load current I_{TRGT}. For example, the LED drive circuit 230 may control (i.e., adjust) a duty cycle DC_{ILOAD} of the load current I_{LOAD} in response to a duty cycle DC_{DIM} of a dimming control signal V_{DIM} provided by the control circuit 240. Further, when using the PWM dimming technique, the LED drive circuit 230 may maintain a frequency f_{ILOAD} of the load current I_{LOAD} in response to a frequency f_{DIM} of the dimming control signal V_{DIM} provided by the control circuit 240. The intensity of the LED light source 102 may be dependent upon the duty cycle DC_{ILOAD} and the frequency f_{ILOAD} of the pulse-width modulated load current I_{LOAD}.

Using the PFM dimming technique, the control circuit 240 may control the peak magnitude I_{PK} of the load current I_{LOAD} through the LED light source 102 to the target load current I_{TRGT}. Using the PFM dimming technique, the control circuit 240 may pulse frequency modulate the load current I_{LOAD} to dim the LED light source 102 and achieve the target load current I_{TRGT}. For example, the LED drive circuit 230 may control (i.e., adjust) a frequency f_{ILOAD} of the load current I_{LOAD} in response to a frequency f_{DIM} of a dimming control signal V_{DIM} provided by the control circuit 240. Further, when using the PFM dimming technique, the LED drive circuit 230 may maintain the duty cycle DC_{ILOAD} of the load current I_{LOAD} in response to a duty cycle DC_{DIM} of the dimming control signal V_{DIM} provided by the control circuit 240. The intensity of the LED light source 102 may be dependent upon the duty cycle DC_{ILOAD} and the frequency f_{ILOAD} of the pulse-width modulated load current I_{LOAD}.

Using the CCR technique, the control circuit 240 may not pulse-width modulate or pulse-frequency modulate the load current I_{LOAD}. Using the CCR technique, the control circuit 240 may adjust the magnitude of the target load current I_{TRGT} so as to adjust the average magnitude I_{AVE} of the load current I_{LOAD} through the LED light source 102. The average magnitude I_{AVE} of the load current I_{LOAD} through the LED light source 102 may be equal to the peak magnitude I_{PK} of the load current I_{LOAD} in the CCR dimming mode.

During the voltage load control mode, the LED drive circuit 230 may regulate the DC voltage of the load voltage V_{LOAD} across the LED light source 102 to a target load voltage V_{TRGT}. The target load voltage V_{TRGT} may be stored in the memory 270. The target load voltage V_{TRGT} may be programmed to be any specific magnitude depending upon the LED light source 102. The control circuit 240 may dim the LED light source 102 using the PWM dimming technique and/or the PFM dimming technique during the voltage load control mode. For example, using the PWM dimming technique, the control circuit 240 may adjust a duty cycle DC_{VLOAD} of the load voltage V_{LOAD} in response to a duty cycle DC_{DIM} of the dimming control signal V_{DIM} to dim the LED light source 102. Using the PFM dimming technique, the control circuit 240 may adjust the frequency f_{ILOAD} of the load voltage V_{LOAD} in response to a frequency f_{DIM} of the dimming control signal V_{DIM} to dim the LED light source 102. An example of a configuration procedure for the LED driver 200 is described in greater detail in U.S. patent application Ser. No. 12/813,989, filed Jun. 11, 2010, entitled CONFIGURABLE LOAD CONTROL DEVICE FOR LIGHT-EMITTING DIODE LIGHT SOURCES, the entire disclosure of which is hereby incorporated by reference.

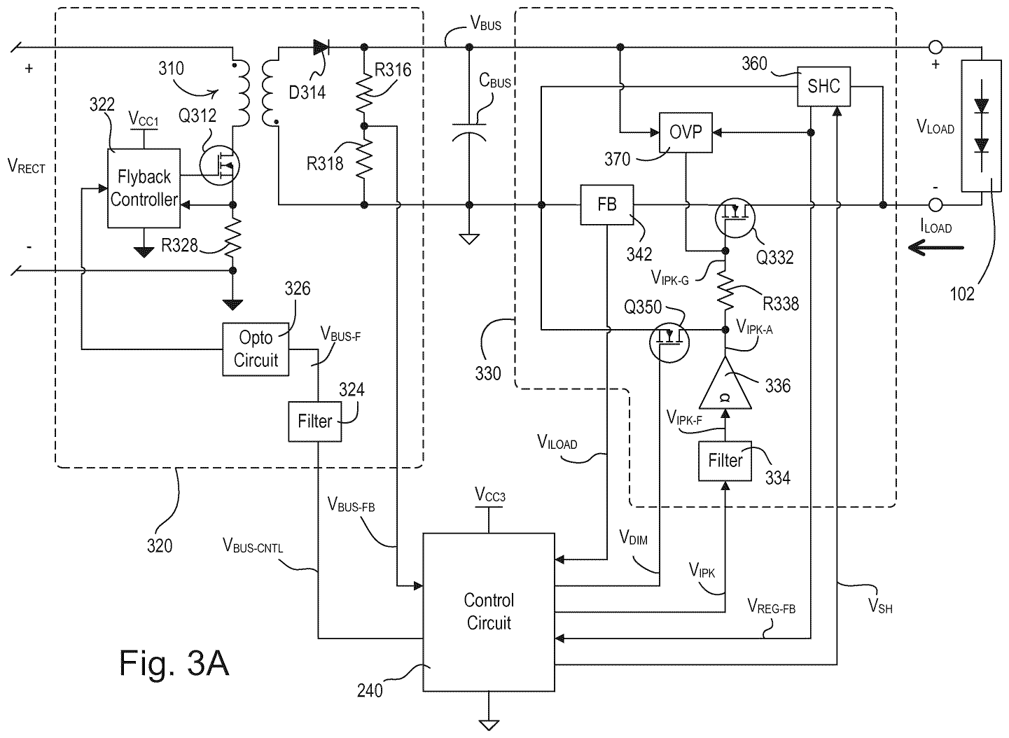

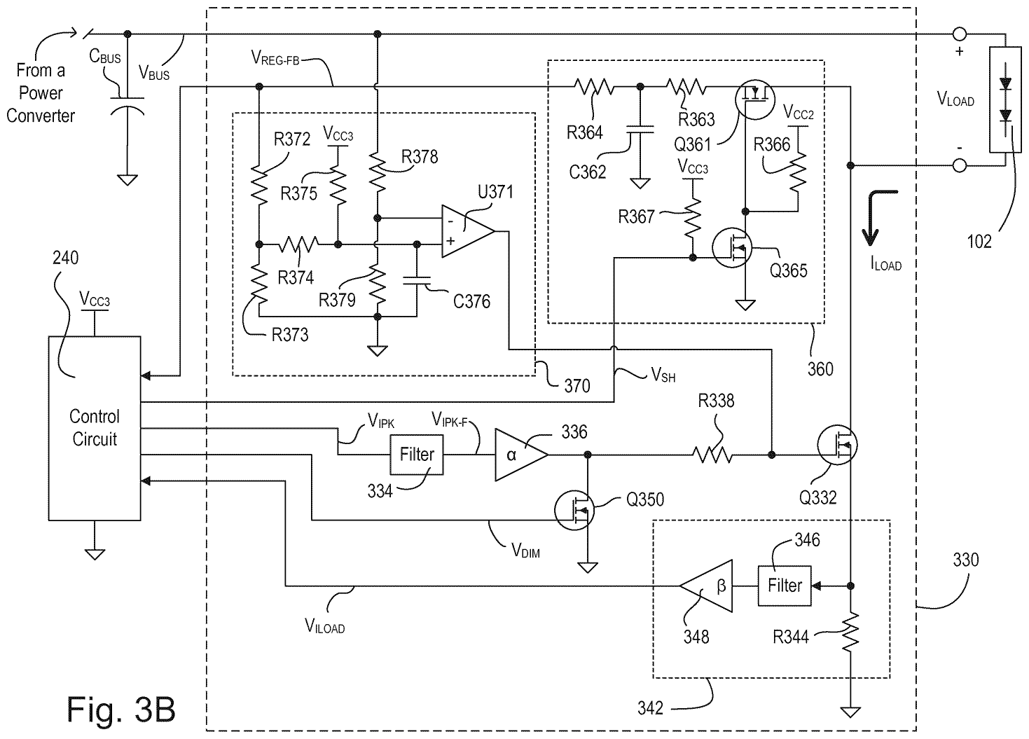

FIG. 3A is a schematic diagram of an example of a flyback converter and an LED drive circuit. A flyback converter 320 may comprise a flyback transformer 310, a field-effect transistor (FET) Q312, a diode D314, a resistor R316, a resistor R318, a flyback control circuit 322, a filter circuit 324, an optocoupler circuit 326, and/or a feedback resistor R328. An LED drive circuit 330 may comprise a regulation field-effect transistor (FET) Q332, a filter circuit 334, an amplifier circuit 336, a gate resistor R338, a feedback circuit 342, a dimming FET Q350, a sample and hold circuit (SHC) 360, and/or an overvoltage protection circuit 370. The flyback converter 320 may be an example of the buck-boost flyback converter 220 of FIG. 2. The LED drive circuit 330 may be an example of the LED drive circuit 230 of FIG. 2. As such, the LED driver 100 of FIG. 1 and/or the LED driver 200 of FIG. 2 may comprise the flyback converter 320 and/or the LED drive circuit 330.

The flyback transformer 310 may comprise a primary winding and a secondary winding. The primary winding may be coupled in series with the field-effect transistor (FET) Q312. Although illustrated as the field-effect transistor (FET) Q312, the primary winding of the flyback transformer 310 may be coupled in series with any flyback switching transistor or other suitable semiconductor switch. The secondary winding of the flyback transformer 310 may be coupled to the bus capacitor C_{BUS} via the diode D314. The bus voltage feedback signal V_{BUS-FB} may be generated by a voltage divider comprising the resistors R316, R318 coupled across the bus capacitor C_{BUS}.

The flyback control circuit 322 may receive the bus voltage control signal V_{BUS-CNTL} from the control circuit 240, for example, via the filter circuit 324 and the optocoupler circuit 326. The filter circuit 324 and the optocoupler circuit 326 may provide electrical isolation between the flyback converter 320 and the control circuit 240. The flyback control circuit 322 may comprise, for example, part number TDA4863, manufactured by Infineon Technologies. The filter circuit 324 may generate a filtered bus voltage control signal V_{BUS-F} using the bus voltage control signal V_{BUS-CNTL}. For example, the filter circuit 324 may comprise a two-stage resistor-capacitor (RC) filter for generating the filtered bus voltage control signal V_{BUS-F}. The filtered bus voltage control signal V_{BUS-F} may comprise a DC magnitude dependent upon the duty cycle DC_{BUS} of the bus voltage control signal V_{BUS-CNTL}. The flyback control circuit 322 may receive a control signal representative of the current through the FET Q312 from the feedback resistor R328, which is coupled in series with the FET Q312.

The flyback control circuit 322 may control the FET Q312 to selectively conduct current through the flyback transformer 310 to generate the bus voltage V_{BUS}. The flyback control circuit 322 may render the FET Q312 conductive and non-conductive at a high frequency (e.g., approximately 150 kHz or less), for example, to control the magnitude of the bus voltage V_{BUS} in response to the DC magnitude of the filtered bus voltage control signal V_{BUS-F} and the magnitude of the current through the FET Q312. For example, the control circuit 240 may increase the duty cycle DC_{BUS} of the bus voltage control signal V_{BUS-CNTL} such that the DC magnitude of the filter bus voltage control signal V_{BUS-F} increases in order to decrease the magnitude of the bus voltage V_{BUS}. The control circuit 240 may decrease the duty cycle DC_{BUS} of the bus voltage control signal V_{BUS-CNTL} to increase the magnitude of the bus voltage V_{BUS}. The filter circuit 324 may provide a digital-to-analog conversion for the control circuit 240 (i.e., from the duty cycle DC_{BUS} of the bus voltage control signal V_{BUS-CNTL} to the DC magnitude of the filtered bus voltage control signal V_{BUS-CNTL}). The control circuit 240 may comprise a digital-to-analog converter (DAC) for generating (e.g., directly generating) the bus voltage control signal V_{BUS-CNTL} having an appropriate DC magnitude for controlling the magnitude of the bus voltage V_{BUS}.

FIG. 3B is a schematic diagram of an example of the LED drive circuit of FIG. 3A. The LED drive circuit 330 may comprise the regulation field-effect transistor (FET) Q332, the filter circuit 334, the amplifier circuit 336, the gate resistor R338, the feedback circuit 342, the dimming FET Q350, the sample and hold circuit 360, and/or the overvoltage protection circuit 370. The feedback circuit 342 may comprise a feedback resistor R344, a filter circuit 346, and/or an amplifier circuit 348. The sample and hold circuit 360 may comprise a FET Q361, a capacitor C362, a resistor R363, a resistor R364, a FET Q365, a resistor R366, and/or a resistor R367. The overvoltage protection circuit 370 may comprise a comparator U371, a resistor R372, a resistor R373, a resistor R374, a resistor R375, a filtering capacitor C376, a resistor R378, and/or a resistor R379.

The LED drive circuit 330 may comprise a linear regulator (i.e., a controllable-impedance circuit) including the regulation field-effect transistor (FET) Q332 coupled in series with the LED light source 102 for conducting the load current I_{LOAD}. Although illustrated as the FET Q332, the LED drive circuit 330 may comprise any power semiconductor switch coupled in series with the LED light source 102 for conducting the load current I_{LOAD}. The regulation FET Q332 may comprise a bipolar junction transistor (BJT), an insulated-gate bipolar transistor (IGBT), or any suitable transistor. The peak current control signal V_{IPK} provided by the control circuit 240 may be coupled to the gate of the regulation FET Q332 through the filter circuit 334, the amplifier circuit 336, and the gate resistor R338. The control circuit 240 may control the duty cycle DC_{IPK} of the peak current control signal V_{IPK} to control the peak magnitude I_{PK} of the load current I_{LOAD} conducted through the LED light source 102 to the target load current I_{TRGT}.

The filter circuit 334 (e.g., a two-stage RC filter) may provide digital-to-analog conversion for the control circuit 240, for example, by generating a filtered peak current control signal V_{IPK-F}. The filtered peak current control signal V_{IPK-F} may have a DC magnitude dependent upon the duty cycle DC_{IPK} of the peak current control signal V_{IPK} and may be representative of the magnitude of the target load current I_{TRGT}. The control circuit 240 may comprise a DAC for generating (e.g., directly generating) the peak current control signal V_{IPK} having an appropriate DC magnitude for controlling the peak magnitude I_{PK} of the load current I_{LOAD}. The amplifier circuit 336 may generate an amplified peak current control signal V_{IPK-A}. The amplifier circuit 336 may provide the amplified peak current control signal V_{IPK-A} to the gate of the regulation transistor Q332 through the resistor R338, such that a drive signal at the gate of the regulation transistor Q332, e.g., a gate voltage V_{IPK-G}, has a magnitude dependent upon the target load current I_{TRGT}. The amplifier circuit 336 may comprise a standard non-inverting operational amplifier circuit having, for example, a gain α of approximately three.

The feedback resistor R344 of the feedback circuit 342 may be coupled in series with the regulation FET Q332, for example, such that the voltage generated across the feedback resistor is representative of the magnitude of the load current I_{LOAD}. For example, the feedback resistor R344 may have a resistance of approximately 0.0375Ω. The filter circuit 346 (e.g., a two-stage RC filter) of the feedback circuit 342 may be coupled between the feedback resistor R344 and the amplifier circuit 348 (e.g., a non-inverting operational amplifier circuit having a gain β of approximately 20). The amplifier circuit 348 may have a variable gain, which for example, may be controlled by the control circuit 240 and could range between approximately 1 and 1000. The amplifier circuit 348 may generate the load current feedback signal V_{ILOAD}. The amplifier circuit 348 may provide the load current feedback signal V_{ILOAD} to the control circuit 240. The load current feedback signal V_{ILOAD} may be representative of an average magnitude I_{AVE} of the load current I_{LOAD}, e.g.,

$${I}_{AVE} = {V}_{ILOAD} / ( β \cdot {R}_{FB} ) , \qquad ( Equation 1 )$$

wherein R_{FB} is the resistance of the feedback resistor R344. Examples of other feedback circuits for the LED drive circuit 330 are described in greater detail in U.S. patent application Ser. No. 12/814,026, filed Jun. 11, 2010, entitled CLOSED-LOOP LOAD CONTROL CIRCUIT HAVING A WIDE OUTPUT RANGE, the entire disclosure of which is hereby incorporated by reference.

When operating in the current load control mode, the control circuit 240 may control the regulation FET Q332 to operate in the linear region, such that the peak magnitude I_{PK} of the load current I_{LOAD} is dependent upon the DC magnitude of the gate voltage V_{IPK-G} at the gate of the regulation FET Q332. In other words, the regulation FET Q332 may provide a controllable-impedance in series with the LED light source 102. If the magnitude of the regulator voltage V_{REG} drops too low, the regulation FET Q332 may be driven into the saturation region, such that the regulation FET Q332 becomes fully conductive and the control circuit 240 is no longer able to control the peak magnitude I_{PK} of the load current I_{LOAD}. Therefore, the control circuit 240 may adjust the magnitude of the bus voltage V_{BUS} to prevent the magnitude of the regulator voltage V_{REG} from dropping below a minimum regulator voltage threshold V_{REG-MIN} (e.g., approximately 0.4 volts). In addition, the control circuit 240 may adjust the magnitude of the bus voltage V_{BUS} to control the magnitude of the regulator voltage V_{REG} to be less a maximum regulator voltage threshold V_{REG-MAX} (e.g., approximately 0.6 volts), for example, to prevent the power dissipated in regulation FET Q332 from becoming too large, thus increasing the total efficiency of the LED driver (e.g., the LED driver 100, the LED driver 200, and/or the like). Since the regulator voltage V_{REG} may have some ripple (e.g., which may be due to the ripple of the bus voltage V_{BUS}), the control circuit 240 may determine the minimum value of the regulator voltage V_{REG} during a period of time and to compare this minimum value of the regulator voltage V_{REG} to the regulator voltage threshold V_{REG-MIN} and the maximum regulator voltage threshold V_{REG-MAX}.

When operating in the voltage load control mode, the control circuit 240 may drive the regulation FET Q332 into the saturation region, for example, such that the magnitude of the load voltage V_{LOAD} is approximately equal to the magnitude of the bus voltage V_{BUS} (e.g., minus the small voltage drops due to the on-state drain-source resistance R_{DS-ON} of the FET regulation Q332 and the resistance of the feedback resistor R344).

The dimming FET Q350 of the LED drive circuit 330 may be coupled between the gate of the regulation FET Q332 and circuit common. The dimming control signal V_{DIM} from the control circuit 240 may be provided to the gate of the dimming FET Q350. When the dimming FET Q350 is rendered conductive, the regulation FET Q332 may be rendered non-conductive. When the dimming FET Q350 is rendered non-conductive, the regulation FET Q332 may be rendered conductive.

While using the PWM dimming technique during the current load control mode, the control circuit 240 may adjust the duty cycle DC_{DIM} of the dimming control signal V_{DIM} (e.g., to adjust the length of an on time t_{ON} that the regulation FET Q332 is conductive) to control when the regulation FET Q332 conducts the load current I_{LOAD} and to control the intensity of the LED light source 102. For example, the control circuit 240 may generate the dimming control signal V_{DIM} using a constant frequency f_{DIM} (e.g., approximately in the range of 500-550 Hz), such that the on time t_{ON} of the dimming control signal V_{DIM} is dependent upon the duty cycle DC_{DIM}, i.e.,

$${t}_{ON} = ( 1 - D {C}_{DIM} ) / {f}_{DIM} . \qquad ( Equation 2 )$$

As the duty cycle DC_{DIM} of the dimming control signal V_{DIM} increases, the duty cycle DC_{ITRGT}, DC_{VTRGT} of the corresponding load current I_{LOAD} or load voltage V_{LOAD} decreases, and vice versa.

While using the PFM dimming technique during the current load control mode, the control circuit 240 may adjust the frequency f_{DIM} of the dimming control signal V_{DIM} to control the frequency at which the regulation FET Q332 conducts the load current I_{LOAD} and to control the intensity of the LED light source 102. For example, the control circuit 240 may generate the dimming control signal V_{DIM} using a constant on time t_{ON}, such that the frequency f_{DIM} of the dimming control signal V_{DIM} is dependent upon the duty cycle DC_{DIM}, i.e.,

$${f}_{DIM} = ( 1 - D {C}_{DIM} ) / {t}_{ON} . \qquad ( Equation 3 )$$

As the duty cycle DC_{DIM} of the dimming control signal V_{DIM} increases, the duty cycle DC_{ITRGT}, DC_{VTRGT} of the corresponding load current I_{LOAD} or load voltage V_{LOAD} decreases, and vice versa.

When using the PWM dimming technique and/or the PFM dimming technique in the current load control mode, the control circuit 240 may control the peak magnitude I_{PK} of the load current I_{LOAD} in response to the load current feedback signal V_{ILOAD} to maintain the average magnitude I_{AVE} of the load current I_{LOAD} constant (i.e., at the target lamp current I_{TRGT}). The control circuit 240 may calculate the peak magnitude I_{PK} of the load current I_{LOAD} from the load current feedback signal V_{ILOAD} and the duty cycle DC_{DIM} of the dimming control signal V_{DIM}, i.e.,

$${I}_{PK} = {I}_{AVE} / ( 1 - D {C}_{DIM} ) . \qquad ( Equation 4 )$$

The load current feedback signal V_{ILOAD} may be representative of the average magnitude I_{AVE} of the load current I_{LOAD}. When using the CCR dimming technique during the current load control mode, the control circuit 240 may maintain the duty cycle DC_{DIM} of the dimming control signal V_{DIM} at a high-end dimming duty cycle DC_{HE} (e.g., approximately 0%, such that the FET Q332 is always conductive) and/or may adjust the target load current I_{TRGT} (e.g., via the duty cycle DC_{IPK} of the peak current control signal V_{IPK}) to control the intensity of the LED light source 102.

The regulator voltage feedback signal V_{REG-FB} may be generated by the sample and hold circuit 360 of the LED drive circuit 330. The regulator voltage feedback signal V_{REG-FB} may be representative of the regulator voltage V_{REG} generated across the series combination of the regulation FET Q332 and the feedback resistor R344 when the regulation FET Q332 is conducting the load current I_{LOAD}. The FET Q361 of the sample and hold circuit 360 may be coupled to the junction of the LED light source 102 and the regulation FET Q332. Although illustrated as the FET Q361, the sample and hold circuit 360 may include any sampling transistor. When the FET Q361 is rendered conductive, the capacitor C362 may charge to approximately the magnitude of the regulator voltage V_{REG} through the resistor R363. The capacitor C362 may have a capacitance of approximately 1 μF. The resistor R363 may have a resistance of approximately 10Ω. The capacitor C362 may be coupled to the control circuit 240 through the resistor R364 for providing the regulator voltage feedback signal V_{REG-FB} to the control circuit 240. The resistor R364 may have a resistance of approximately 12.1 kΩ. The gate of the FET Q361 may be coupled to circuit common through the FET Q365 and to the second isolated supply voltage V_{CC2} through the resistor R366. The resistor R366 may have a resistance of approximately 20 kΩ. The gate of the second FET Q365 may be coupled to the third non-isolated supply voltage V_{CC3} through the resistor R367. The resistor R367 may have a resistance of approximately 10 kΩ.

The control circuit 240 may generate a sample and hold control signal VSH that is operatively coupled to the control input (i.e., the gate) of the FET Q365 of the sample and hold circuit 360. The sample and hold control signal VSH may be coupled to the FET Q365 to render the FET Q361 conductive and non-conductive to controllably charge the capacitor C362 to the magnitude of the regulator voltage V_{REG}. For example, when using the PWM dimming mode and/or the PFM dimming mode, the control circuit 240 may render the FET Q361 conductive during an on time t_{ON} (e.g., each on time t_{ON}) of the dimming control signal V_{DIM} (i.e., when the dimming FET Q350 is non-conductive and the regulation FET Q332 is conductive). When the FET Q361 is rendered conductive during the on time t_{ON} of the dimming control signal V_{DIM}, the regulator voltage feedback signal V_{REG-FB} may be representative of the magnitude of the regulator voltage V_{REG} when the regulation FET Q332 is conducting the load current I_{LOAD}. When the control circuit 240 is using the CCR dimming mode, the FET Q361 may be rendered conductive at all times.

The overvoltage protection circuit 370 of the LED drive circuit 330 may be responsive to the magnitude of the bus voltage V_{BUS} and/or the magnitude of the regulator feedback voltage V_{REG-FB}. The difference between the magnitudes of the bus voltage V_{BUS} and the regulator feedback voltage V_{REG-FB} may be representative of the magnitude of the load voltage V_{LOAD} across the LED light source 102. The comparator U371 of the overvoltage protection circuit 370 may have an output coupled to the gate of the regulation FET Q332 for rendering the FET non-conductive if the load voltage V_{LOAD} exceeds an overvoltage threshold. The overvoltage protection circuit 370 may comprise a resistor divider that includes the resistors R372, R373. The resistor divider that includes the resistors R372, R373 may receive the regulator feedback voltage V_{REG-FB}. The junction of the resistors R372, R373 may be coupled to the non-inverting input of the comparator U371 through the resistor R374. The non-inverting input may be coupled to the third non-isolated supply voltage V_{CC3} through the resistor R375 and/or to circuit common through the filtering capacitor C376. The filtering capacitor C376 may have a capacitance of approximately 10 μF.

The overvoltage protection circuit may comprise a resistor divider that includes the resistors 3478, 379. The resistor divider that includes resistors R378, R379 may be coupled between the bus voltage V_{BUS} and circuit common. The junction of the resistors R378, R379 may be coupled to the inverting input of the comparator U371, such that, for example, the magnitude of the voltage at the non-inverting input of the comparator U371 may be responsive to the regulator feedback voltage V_{REG-FB} and/or such that the magnitude of the voltage at the inverting input of the comparator U371 may be responsive to the bus voltage V_{BUS}. The comparator U371 may operate to render the regulation FET Q332 non-conductive if the difference between the magnitudes of the bus voltage V_{BUS} and the regulator feedback voltage V_{REG-FB} exceeds the overvoltage threshold.

The resistances of the resistors R372, R373, R374, R375, R378, R379 of the overvoltage protection circuit 370 may be determined such that the voltage at the non-inverting input of the comparator U371 is proportional to the magnitude of the regulator feedback voltage V_{REG-FB}. Accordingly, the magnitude of the bus voltage V_{BUS} that may cause the voltage at the inverting input of the comparator U371 to exceed the voltage at the non-inverting input increases in proportional to the magnitude of the regulator feedback voltage V_{REG-FB}, such that the overvoltage threshold that the load voltage V_{LOAD} exceeds to render the regulation FET Q332 non-conductive remains approximately constant as the magnitude of the regulator feedback voltage V_{REG-FB} changes. The resistances of the resistors R375, R374 may be greater than the resistances of the resistors R372, R373 to avoid loading the regulator feedback voltage V_{REG-FB}.

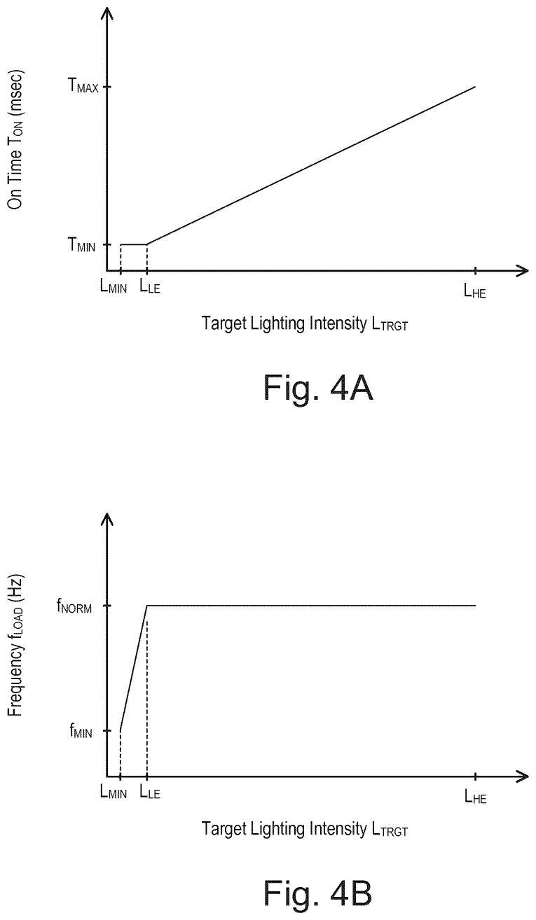

FIG. 4A is a graph that illustrates an example of the relationship between an on-time T_{ON} of a load current of an LED driver (e.g., the LED driver 100 of FIG. 1, the LED driver 200 of FIG. 2, and/or the like) and a target lighting intensity L_{TRGT} of an LED light source (e.g., the LED light source 102 and/or the like). FIG. 4B is a graph that illustrates an example of the relationship between a frequency f_{LOAD} of a load current of an LED driver (e.g., the LED driver 100 of FIG. 1, the LED driver 200 of FIG. 2, and/or the like) and a target lighting intensity L_{TRGT} of an LED light source (e.g., the LED light source 102 and/or the like).

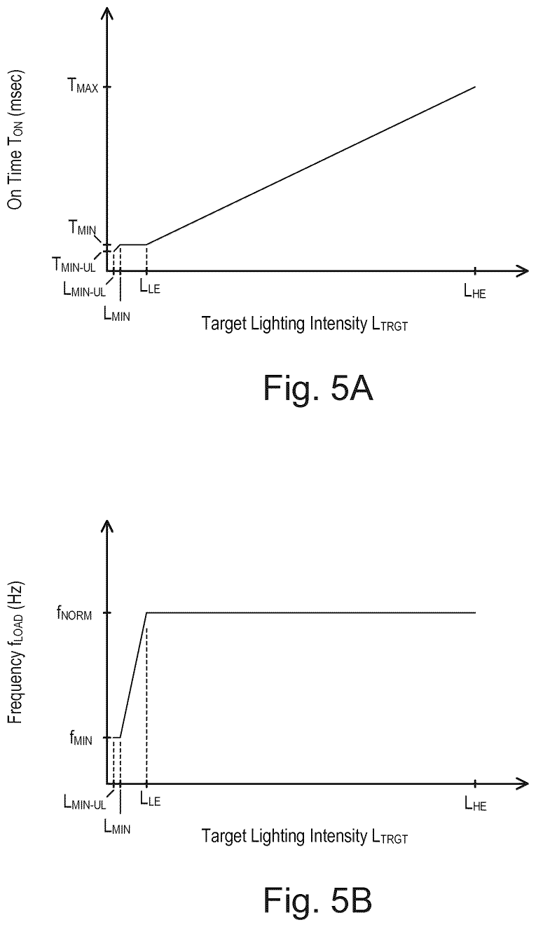

FIG. 5A is a graph that illustrates an example of the relationship between an on-time T_{ON} of a load current of an LED driver (e.g., the LED driver 100 of FIG. 1, the LED driver 200 of FIG. 2, and/or the like) and a target lighting intensity L_{TRGT} of an LED light source (e.g., the LED light source 102 and/or the like). FIG. 5B is a graph that illustrates an example of the relationship between a frequency f_{LOAD} of a load current of an LED driver (e.g., the LED driver 100 of FIG. 1, the LED driver 200 of FIG. 2, and/or the like) and a target lighting intensity L_{TRGT} of an LED light source (e.g., the LED light source 102 and/or the like). One or more of the embodiments described with relation to FIGS. 4A, 4B, 5A, and/or 5B may be performed by an LED driver (e.g., the LED driver 100 of FIG. 1, the LED driver 200 of FIG. 2, and/or the like) using a current control mode and/or a voltage control mode.

The control circuit 240 may be configured to control the intensity of the LED light source 102 by pulse width modulating the load current I_{LOAD} when the target intensity is above a predetermined threshold and control the intensity of the LED light source 102 by pulse frequency modulating the load current I_{LOAD} when the target intensity is below the predetermined threshold. The predetermined threshold may be, for example, a low-end intensity L_{LE} (e.g., 1%) as shown in FIGS. 4A-4B and FIGS. 5A-5B. Pulse width modulating the load current I_{LOAD} may comprise maintaining a frequency f_{LOAD} of the load current I_{LOAD} constant and adjusting an on time T_{ON} of the load current I_{LOAD}. Pulse frequency modulating the load current I_{LOAD} may comprise maintaining the on time T_{ON} of the load current I_{LOAD} constant and adjusting the frequency f_{LOAD} of the load current I_{LOAD}.

When the LED driver is operating in the PWM dimming mode, the control circuit 240 may adjust the duty cycle DC_{ILOAD} of the pulse-width modulated load current I_{LOAD} to dim the LED light source 102 between the high-end intensity L_{HE} (e.g., approximately 100%) and the low-end intensity L_{LE} (e.g., approximately 1%) in response to the phase-control signal V_{PC}. For example, the control circuit 240 may render the dimming FET Q350 conductive for an on time T_{ON} and non conductive for an off time T_{OFF} during a period (e.g., each period) T_{PWM} of the pulse-width modulated load current I_{LOAD}. The control circuit 240 may hold a frequency f_{LOAD} of the pulse-width modulated load current I_{LOAD} constant at a normal PWM frequency f_{NORM} (e.g., approximately in the range of 500-550 Hz) and may adjust the length of the on time T_{ON} to dim the LED light source 102 between the high-end intensity L_{HE} and the low-end intensity L_{LE}, for example, as shown in FIGS. 4A-4B and FIGS. 5A-5B. For example, the length of the on time T_{ON} may be controlled between a maximum on time T_{MAX} (e.g., approximately 1.8 msec) corresponding to the high-end intensity L_{HE} (e.g., the duty cycle DC_{ILOAD} may equal approximately 100%) of the LED light source 102 and a minimum on time T_{MIN} (e.g., approximately 18 μsec) corresponding to the low-end intensity L_{LE} (e.g., the duty cycle DC_{ILOAD} may equal approximately 1%) of the LED light source 102.

The LED driver may adjust (e.g., fade) the intensity of the LED light source 102 from the present intensity L_{PRES} to off (e.g., 0%) over a fade time period T_{FADE}. When fading the intensity of the LED light source 102 to off, the control circuit 240 may adjust the intensity of the LED light source 102 below the low-end intensity L_{LE} (e.g., 1%), for example, to a minimum intensity L_{MIN}, to an ultra-low minimum intensity L_{MIN-UL}, and/or to off. Hardware limitations of the control circuit 240 (e.g., a minimum pulse width that may be generated by the control circuit) may prevent the length of the on time T_{ON} of the pulse-width modulated load current I_{LOAD} from being adjusted below the minimum on time T_{MIN}, for example, when the frequency f_{LOAD} of the pulse-width modulated load current I_{LOAD} is at the normal PWM frequency f_{NORM}.

The control circuit 240 may adjust the intensity of the LED light source 102 below the low-end intensity L_{LE} by pulse frequency modulating the load current I_{LOAD}. For example, the control circuit 240 may adjust the intensity of the LED light source 102 below the low-end intensity L_{LE} to the minimum intensity L_{MIN} by the maintaining the length of the on time T_{ON} constant at the minimum on time T_{MIN} and decreasing the frequency f_{LOAD} of the pulse-width modulated load current I_{LOAD}, for example, as shown in FIGS. 4A-4B and 5A-5B. The control circuit 240 may decrease the intensity of the LED light source 102 from the low-end intensity L_{LE} to the minimum intensity L_{MIN} (e.g., approximately 0.1%) by decreasing the frequency f_{LOAD} from the normal PWM frequency f_{NORM} to a minimum PWM frequency f_{MIN} (e.g., approximately 120 Hz). As such, the control circuit 240 may adjust the intensity of the LED light source 102 by adjusting the length of the on time T_{ON} and maintaining the frequency f_{LOAD} when the target intensity L_{TRGT} is greater than the low-end intensity L_{LE}, and by adjusting the frequency f_{LOAD} and maintaining the on time T_{ON} when the target intensity L_{TRGT} is less than the low-end intensity L_{LE}. In one or more embodiments, the control circuit 240 may decrease the intensity of the LED light source 102 from the low-end intensity L_{LE} to off by decreasing the frequency f_{LOAD}, for example, from the normal PWM frequency f_{NORM} to the minimum PWM frequency f_{MIN}.

The control circuit 240 may control the intensity of the LED light source 102 below the minimum intensity L_{MIN} to an ultra-low minimum intensity L_{MIN-UL}, for example, as shown in FIGS. 5A-5B. The control circuit 240 may control the intensity of the LED light source 102 below the minimum intensity L_{MIN} to an ultra-low minimum intensity L_{MIN-UL} by pulse width modulating the load current. For example, the control circuit 240 may maintain the frequency f_{LOAD} of the load current I_{LOAD} constant at the minimum PWM frequency f_{MIN} (e.g., approximately 120 Hz) and decrease the on time T_{ON} below the minimum on time T_{MIN}. For example, the control circuit 240 may decrease the on time T_{ON} from the minimum on time T_{MIN} to an ultra-low minimum on time T_{MIN-UL} while maintaining the frequency f_{LOAD} constant at the minimum PWM frequency f_{MIN} to control the intensity of the LED light source 102 below the minimum intensity L_{MIN} to an ultra-low minimum intensity L_{MIN-UL}. For instance, the control circuit may dim the LED light source to off by pulse width modulating the load current (i.e., the ultra-low minimum intensity may be 0% intensity). In such examples, the minimum PWM frequency may be decreased below 120 Hz. The control circuit 240 may decrease the on time T_{ON} until the hardware limitations of the control circuit 240 prevent the on time T_{ON} from being decreased any further.

The control circuit 240 may be configured to dim the LED light source 102 to off. The control circuit 240 may be configured to control the intensity of the LED light source 102 from the predetermined threshold to off by pulse frequency modulating the load current I_{LOAD}. The control circuit 240 may be configured to pulse width modulate the load current I_{LOAD} when the target intensity is below the minimum intensity L_{MIN}. As such, the control circuit 240 may be configured to control the intensity of the LED light source 102 from the minimum intensity L_{MIN} to off by pulse width modulating the load current I_{LOAD}.

In one or more embodiments, the control circuit 240 may control the intensity of the LED light source 102 by decreasing the magnitude of the DC bus voltage V_{BUS}. For example, the control circuit 240 may be configured to control the intensity of the LED light source 102 below the minimum intensity level L_{MIN} by decreasing the magnitude of the DC bus voltage V_{BUS}. The control circuit may be configured to maintain a frequency f_{LOAD} of the load current I_{LOAD} constant (e.g., at the minimum PWM frequency f_{MIN}), maintain an on time T_{ON} of the load current I_{LOAD} constant (e.g., at the minimum on time T_{MIN} or at the ultra-low minimum on time T_{MIN-UL}), and decrease a magnitude of the DC bus voltage V_{BUS} when the target intensity L_{TRGT} is below the minimum intensity L_{MIN}. For example, control circuit may control the intensity of the LED light source 102 to off by decreasing the magnitude of the DC bus voltage V_{BUS}.

The high-end intensity L_{HE} may be approximately 100%. The low-end intensity L_{LE} may be approximately 1%. The minimum intensity L_{MIN} may be approximately in the range of 0.1-1%. The ultra-low minimum intensity L_{MIN-UL} may be approximately in the range of 0-0.1%. For example, the ultra-low minimum intensity L_{MIN-UL} may be 0% (i.e., off). The maximum on time T_{MAX} may be approximately 1.8 msec. The minimum on time T_{MIN} may be approximately 18 μsec. The ultra-low minimum on time T_{MIN-UL} may be approximately 1 μsec. The normal PWM frequency f_{NORM} may be approximately in the range of 500-550 Hz. The minimum PWM frequency f_{MIN} may be approximately in the range of 120-150 Hz.

Although illustrated in FIGS. 4A-4B and FIGS. 5A-5B as controlling the length of the on time T_{ON} of the load current I_{LOAD} between the high-end intensity L_{HE} and the minimum intensity L_{MIN} and controlling the frequency f_{LOAD} of the load current I_{LOAD} between the minimum intensity L_{MIN} and the ultra-low minimum intensity L_{MIN-UL}, the control circuit 240 may be configured to control the intensity of the LED light source 102 by pulse width modulating the load current I_{LOAD} when the target intensity is within a first intensity range and control the intensity of the LED light source 102 by pulse frequency modulating the load current I_{LOAD} when the target intensity is within a second intensity range. The first intensity range may be greater than or less than the second intensity range. Further, the control circuit 240 may be configured to control the intensity of the LED light source 102 by pulse width modulating the load current I_{LOAD} when the target intensity is within a third intensity range. The third intensity range may be below a known operating range of the LED light source 102. As such, the control circuit 240 may control the LED light source 102 by adjusting a first parameter (e.g., on time T_{ON} of the load current I_{LOAD}) to a control point that produces a known, reliable response of the LED light source 102 (e.g., the low-end intensity L_{LE}), adjusting a second parameter (e.g., the frequency f_{LOAD} of the load current I_{LOAD}) to a second control point that may or may not produce a known reliable response of the LED light source 102, and adjusting the first parameter past the second control point, which may produce an unknown and potentially unreliable response of the LED light source 102. However, this may be acceptable because the control circuit 240 may be fading the LED light source 102 to off.

The control circuit 240 may be configured to receive a command and control (e.g., dim) the intensity of the LED light source 102 below the first intensity range and below the second intensity range to off. For example, the load control circuit may be configured to control the intensity of the LED light source 102 below the second intensity range to off by pulse width modulating and/or pulse frequency modulating the load current I_{LOAD}. The load control circuit may be configured to control the intensity of the LED light source 102 below the first intensity range and below the second intensity range to off by maintaining the frequency f_{LOAD} of the load current I_{LOAD} constant, maintaining the on time T_{ON} of the load current I_{LOAD} constant, and decreasing the magnitude of the DC bus voltage V_{BUS}.

The control circuit 240 may control the length of the on time T_{ON} and/or the frequency f_{LOAD} of the load current I_{LOAD} to adjust the intensity of the LED light source 102 between the minimum intensity L_{MIN} (e.g., 0.1%) and the high-end intensity L_{HE} (e.g., 100%) during, for example, normal operation of the LED driver (i.e., not only when the LED driver is fading the intensity of the LED light source to off).

One or more of the embodiments described herein (e.g., as performed by a load control device) may be used to decrease the intensity of a lighting load and/or increase the intensity of the lighting load. For example, one or more embodiments described herein may be used to adjust the intensity of the lighting load from on to off, off to on, from a higher intensity to a lower intensity, and/or from a lower intensity to a higher intensity. For example, although described as adjusting the intensity of the LED light source 102 from the present intensity L_{PRES} to off (e.g., 0%), the LED driver may adjust (e.g., fade) the intensity of the LED light source 102 from off (e.g., 0%) to a target intensity L_{TRGT} (e.g., an intensity between an ultra-low minimum intensity L_{MIN-UL} and a high-end intensity L_{HE}) to over the fade time period T_{FADE} (e.g., in accordance with FIGS. 4A, 4B, 5A, and/or 5B).

Although described with reference to an LED driver, one or more embodiments described herein may be used with other load control devices. For example, one or more of the embodiments described herein may be performed by a variety of load control devices that are configured to control of a variety of electrical load types, such as, for example, a LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, controllable circuit breaker, or other switching device for turning electrical loads or appliances on and off; a plug-in load control device, controllable electrical receptacle, or controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or computer monitor; a power supply; an audio system or amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

What is claimed is:

1. A light-emitting diode (LED) driver apparatus comprising:
LED driver circuitry to receive a bus voltage and provide a load current output; and
control circuitry to:
control the bus voltage provided to the LED driver circuitry;
receive an input indicative of a target intensity;
determine whether the target intensity is less than or equal to a defined low-end trim setting;
control the load current output of the LED driver circuitry using a first modulation technique responsive to the determination that the target intensity is less than or equal to the low-end trim setting; and
control the load current output of the LED driver circuitry using a second modulation technique different from the first modulation technique responsive to the determination that the target intensity is greater than the low-end trim setting.

2. The LED driver apparatus of claim 1 wherein to control the load current output of the LED driver circuitry using a first modulation technique, the control circuitry to further:
determine a minimum on-time for the load current output;
adjust the load current output of the LED driver circuitry to the determined minimum on-time; and
adjust a frequency of the load current output of the LED driver circuitry between a normal pulse width modulation (PWM) frequency and a minimum PWM frequency.

3. The LED driver apparatus of claim 2 wherein to control the load current output of the LED driver circuitry using a second modulation technique, the control circuitry to further:
set the PWM frequency of the load current to a defined PWM frequency; and
adjust a pulse width of the load current output of the LED driver circuitry.

4. The LED driver apparatus of claim 1, wherein the control circuitry to further:
determine whether received target intensity is less than or equal to a minimum intensity value; and
control the load current output of the LED driver circuitry using a third modulation technique different from the first modulation technique and the second modulation technique responsive to the determination that the received target intensity is less than or equal to the minimum intensity value.

5. The LED driver apparatus of claim 4, wherein to control the load current output of the LED driver circuitry using a third modulation technique different from the first modulation technique and the second modulation technique, the control circuitry to further:
adjust a frequency of the load current output of the LED driver circuitry to a minimum PWM frequency; and
adjust the load current output of the LED driver circuitry below the minimum load current on-time value.

6. The LED driver apparatus of claim 4, wherein to control the load current output of the LED driver circuitry using a third modulation technique different from the first modulation technique and the second modulation technique, the control circuitry to further:
set the PWM frequency of the load current to a minimum PWM frequency;
adjust the load current output of the LED driver circuitry to the determined minimum on-time; and
reduce the bus voltage provided to the LED driver circuitry.

7. A light-emitting diode (LED) driver control method, comprising:
controlling by LED driver control circuitry, a bus voltage provided to LED driver circuitry;
receiving by the LED driver control circuitry, an input indicative of a target intensity;
determining by the LED driver control circuitry, whether the target intensity is less than or equal to a defined low-end trim setting;
controlling by the LED driver control circuitry, the load current output of the LED driver circuitry using a first modulation technique responsive to the determination that the target intensity is less than or equal to the low-end trim setting; and
controlling by the LED driver control circuitry, the load current output of the LED driver circuitry using a second modulation technique different from the first modulation technique responsive to the determination that the target intensity is greater than the low-end trim setting.

8. The LED driver control method of claim 7 wherein controlling the load current output of the LED driver circuitry using a first modulation technique further comprises:
determining by the LED driver control circuitry, a minimum on-time for the load current output;
adjusting by the LED driver control circuitry, the load current output of the LED driver circuitry to the determined minimum on-time; and
adjusting by the LED driver control circuitry, a frequency of the load current output of the LED driver circuitry between a normal pulse width modulation (PWM) frequency and a minimum PWM frequency.

9. The LED driver control method of claim 8 wherein controlling the load current output of the LED driver circuitry using a second modulation technique further comprises:
setting by the LED driver control circuitry, the PWM frequency of the load current to a defined PWM frequency; and
adjusting by the LED driver control circuitry, a pulse width of the load current output of the LED driver circuitry.

10. The LED driver control method of claim 7, further comprising:
determining by the LED driver control circuitry, whether received target intensity is less than or equal to a minimum intensity value; and
controlling by the LED driver control circuitry, the load current output of the LED driver circuitry using a third modulation technique different from the first modulation technique and the second modulation technique responsive to the determination that the received target intensity is less than or equal to the minimum intensity value.

11. The LED driver control method of claim 10, wherein controlling the load current output of the LED driver circuitry using a third modulation technique further comprises:
adjusting by the LED driver control circuitry, a frequency of the load current output of the LED driver circuitry to a minimum PWM frequency; and
adjusting by the LED driver circuitry, the load current output of the LED driver circuitry below the minimum load current on-time value.

12. The LED driver control method of claim 10, wherein controlling the load current output of the LED driver circuitry using a third modulation technique further comprises:
setting by the LED driver control circuitry, the PWM frequency of the load current to a minimum PWM frequency;
adjusting by the LED driver control circuitry, the load current output of the LED driver circuitry to the determined minimum on-time; and
reducing by the LED driver control circuitry, the bus voltage provided to the LED driver circuitry.

13. A non-transitory, machine-readable, storage device that includes instructions that, when executed by LED driver control circuitry, cause the LED driver control circuitry to:
control a bus voltage provided to LED driver circuitry;
receive an input indicative of a target intensity;
determine whether the target intensity is less than or equal to a defined low-end trim setting;
control the load current output of the LED driver circuitry using a first modulation technique responsive to the determination that the target intensity is less than or equal to the low-end trim setting; and
control the load current output of the LED driver circuitry using a second modulation technique different from the first modulation technique responsive to the determination that the target intensity is greater than the low-end trim setting.

14. The non-transitory, machine-readable, storage device of claim 13 wherein the instructions that cause the LED driver control circuitry to control the load current output of the LED driver circuitry using a first modulation technique further cause the LED driver control circuitry to:
determine a minimum on-time for the load current output;
adjust the load current output of the LED driver circuitry to the determined minimum on-time; and
adjust a frequency of the load current output of the LED driver circuitry between a normal pulse width modulation (PWM) frequency and a minimum PWM frequency.

15. The non-transitory, machine-readable, storage device of claim 14 wherein the instructions that cause the LED driver control circuitry to control the load current output of the LED driver circuitry using a second modulation technique further cause the LED driver control circuitry to:
set the PWM frequency of the load current to a defined PWM frequency; and
adjust a pulse width of the load current output of the LED driver circuitry.

16. The non-transitory, machine-readable, storage device of claim 13 wherein the instructions, when executed by the LED driver control circuitry, further cause the LED driver control circuitry to:
determine whether received target intensity is less than or equal to a minimum intensity value; and
control the load current output of the LED driver circuitry using a third modulation technique different from the first modulation technique and the second modulation technique responsive to the determination that the received target intensity is less than or equal to the minimum intensity value.

17. The non-transitory, machine-readable, storage device of claim 16 wherein the instructions that cause the LED driver control circuitry to control the load current output of the LED driver circuitry using a third modulation technique further cause the LED driver control circuitry to:
adjust a frequency of the load current output of the LED driver circuitry to a minimum PWM frequency; and
adjust the load current output of the LED driver circuitry below the minimum load current on-time value.

18. The non-transitory, machine-readable, storage device of claim 16 wherein the instructions that cause the LED driver control circuitry to control the load current output of the LED driver circuitry using a third modulation technique further cause the LED driver control circuitry to:
set the PWM frequency of the load current to a minimum PWM frequency;
adjust the load current output of the LED driver circuitry to the determined minimum on-time; and
reduce the bus voltage provided to the LED driver circuitry.
